(19) United States
(12) Patent Application Publication
(10) Pub. No.: US 2005/0006394 A1
(43) Pub. Date: Jan. 13, 2005

(54) High-pressure gas container

(76) Inventors: Kazuo Fujihara, Nishikasugai-gun (JP); Tetsuya Suzuki, Nishikasugai-gun (JP); Takashi Mitsuda, Nishikasugai-gun (JP); Takashi Maeno, Nishikasugai-gun (JP)

Correspondence Address: POSZ & BETHARDS, PLC, 11250 ROGER BACON DRIVE, SUITE 10, RESTON, VA, 20190, US

(21) Appl. No.: 10/864,807

(22) Filed: Jun. 10, 2004

(30) Foreign Application Priority Data
Jun. 12, 2003 (JP) P2003-168298

(51) Int. Cl. F16L 55/16

(52) U.S. Cl. 220/581

(57) ABSTRACT

A high-pressure gas container is provided with a hollow liner portion made of resin and a regulating portion disposed on the outer peripheral side of the liner portion. Reinforcing ribs projected toward the hollow inside of the liner portion and used for reinforcing the liner portion are provided integrally with the liner portion on the inner peripheral side of the liner portion. Providing the reinforcing ribs results in increasing the strength of the high-pressure gas container. Moreover, providing the reinforcing ribs integrally with the liner portion makes it possible to reduce not only the number of parts and that of manufacturing man-hours required to produce the high-pressure gas container, so that the high-pressure gas containers are producible less costly.

The present application is based on Japanese Patent Application No. 2003-168298, the entire contents of which are incorporated herein by reference.

### BACKGROUND OF THE INVENTION

1. Field of the Invention

The present invention relates generally to high-pressure gas containers including those for being filled with various kinds of compressed gas such as CNG (Compressed Natural Gas), liquefied gas such as LNG (Liquefied Natural Gas) and LPG (Liquefied Petroleum Gas, and any other kind of high-pressure gas.

2. Description of the Related Art

High-pressure gas containers for being filled with various kinds of high-pressure gas such as compressed gas and liquefied gas have conventionally been made of iron; however, the problem is that the iron-made high-pressure gas container tends to become greater in weight because the specific gravity of iron is as great as 7.9. Therefore, there have existed many problems arising from an increase in fuel consumption of vehicles when the vehicles are loaded with high-pressure gas containers filled with fuel gas; difficulties in handling high-pressure gas containers as their weight increases; and restrictions imposed on their shapes because of inferior formability of iron material. For these problems, high-pressure gas containers made of such a material as aluminum and resins are increasingly developed in recent years.

Among various materials, resin material is lightweight and excellent in shock-resistance and moldability, whereupon the resin material shows promise as what is able to realize weight reduction in the high-pressure gas container as well as improvement in shaping freedom. In the case of forming high-pressure gas containers by using resin material, the high-pressure gas container expands when the high-pressure gas container is filled with compressed gas and the high-pressure gas container thus expanded once contracts when the compressed gas is discharged. For this reason, repetition of filling up and discharging the compressed gas results in making the high-pressure gas container repeat expansion and contraction, thus deteriorating the resin material, which causes anxiety that the strength of the high-pressure gas container lowers.

Therefore, such a high-pressure gas container has here to fore been formed with a hollow liner portion and a regulating portion. The regulating portion which is formed of resin material having low gas permeability and satisfies the prescribed pressure-resistant standard is arranged on the outer peripheral side of the liner portion.

In this case, because the expansion of the liner portion followed by the injection of high-pressure gas is regulated by the regulating portion, the expansion and the contraction of the liner portion are restrained, so that the deterioration of the resin material used to form the liner portion is reduced. Accordingly, the pressure-resistance and shock-resistance of the high-pressure gas container are improved as the liner portion is reinforced by the regulating portion, whereby the strength of the high-pressure gas container is also improved.

As the regulating portion, what is generally in use is formed of FRP by winding reinforced fiber such as carbon fiber and glass fiber impregnated with molten thermohardening resin on the outer peripheral side of the liner portion and heat-hardening the resin to make the reinforced fibers adhere to each other. With the FRP formed by winding as a reinforcing layer, the expansion of the liner portion is regulated even against the tensile force of the reinforced fiber, so that the pressure-resistance of the high-pressure gas container is improved further.

When the reinforced fiber is wound on the liner portion, however, the liner portion is pressed into the hollow inside by the tensile force of the reinforced fiber, whereby the liner portion contracts. With the liner portion thus contracted, the tensile force of the reinforced fiber positioned on the liner portion side decreases, so that the strength derived from the regulating portion is reduced. Further, as the dimension of the external shape of the gas container becomes smaller, accompanied with the contraction of the liner portion, the problem is that the installation accuracy is deteriorated when the gas container is mounted on the vehicle, for example.

Consequently, the tensile force of the reinforced fiber is sufficiently retained and the pressure-resistance derived from the tensile force of the reinforced fiber is made adequate by increasing the winding quantity of the reinforced fiber impregnated with molten resin and providing a thicker regulating portion so as to make the dimension of the external shape of the gas container as great as desired. However, the amount of the reinforced fiber and thermoplastic resin for use grows greater and the problem in this case is that the material cost of the high-pressure gas container rises.

On the other hand, there exists an art to increasing the strength of a high-pressure gas container through the steps of forming a plurality of substantially cylindrical reinforcing ribs beforehand, arranging these reinforcing ribs axially in a row on the innermost peripheral side of the high-pressure gas container and providing an external cylinder, which is reinforced by reinforcing ribs (e.g., JP-A-1-176899).

Each of the reinforcing ribs with one end projecting in a ringlike form in the internal circumferential direction as shown in JP-A-1-176899 is substantially cylinder-shaped with its axial length being shorter than the external cylinder. Many reinforcing ribs like these are provided axially in a row on the inner peripheral side of the external cylinder, so that many ringlike portions are also axially provided in a row. The strength of the high-pressure gas container in the circumferential direction is thus increased by the substantially ringlike portions over the whole axial direction.

When the reinforcing ribs shown in JP-A-1-176899 are formed of resin and applied to the resin high-pressure gas container, the strength in the circumferential direction at least is secured by the reinforcing ribs even when the FRP layer is formed by winding on the outer peripheral side of the reinforcing ribs, for example, and contraction in the circumferential direction at least is reduced.

However, the reinforcing ribs shown in JP-A-1-176899 are prepared by joining and integrating many reinforcing ribs separately formed. Therefore, the problem in this case is that the number of parts required for the high-pressure gas container grows larger when many reinforcing ribs are arranged like this. Moreover, it is needed to join the reinforcing ribs together for integration and there develops a problem concerning an increase in the number of manufacturing man-hours.

Unless the reinforcing ribs are joined together precisely, the high-pressure gas filled in the high-pressure gas container may leak out to the outer peripheral side through a gap between the reinforcing ribs. Therefore, it is considered necessary to provide an additional liner portion having low gas permeability on the outer peripheral side of the reinforcing ribs. In this case, however, the number of manufacturing man-hours notably increases because it has to be arranged forming the plurality of reinforcing ribs, joining the plurality of reinforcing ribs together for integration, forming the liner portion on the outer peripheral side of the reinforcing ribs and additionally forming a regulating portion on the outer layer of the liner portion. Consequently, providing the reinforcing ribs like this still poses a problem in that the high-pressure gas container thus obtained tends to become costly.

When the reinforcing ribs shown in JP-A-1-176899 is provided, additionally providing cylindrical reinforcing ribs extending axially, for example, is needed, whereby the number of parts and that of manufacturing man-hours increase further; the problem is that the high-pressure gas container tends to become more costly.

### SUMMARY OF THE INVENTION

An object of the invention made in consideration of the circumstances above is to provide a high-pressure gas container excellent in strength and producible less costly.

A high-pressure gas container according to the invention is formed with a hollow liner portion made of resin and a regulating portion disposed on the outer peripheral side of the liner portion and characterized in that reinforcing ribs for reinforcing the liner portion are provided integrally with the liner portion on the inner peripheral side of the liner portion in such a manner as to be projected toward the hollow inside of the liner portion.

The reinforcing ribs are provided such that the reinforcing ribs are extended in the axial direction of the liner portion.

The reinforcing ribs are spirally extended in the axial direction of the liner portion while wound up along the inner surface of the liner portion.

The reinforcing ribs and the liner portion are integrated before the regulating portion is arranged.

### BRIEF DESCRIPTION OF THE DRAWINGS

FIG. 1 is a schematic sectional view of a high-pressure gas container in its axial direction according to Embodiment 1 of the invention.

FIG. 2 is an enlarged view of a main part of a portion shown by a broken line a in FIG. 1.

FIG. 3 is a schematic sectional view taken on line A-A′ in FIG. 1.

FIG. 4 is a schematic process drawing illustrating a method of producing the high-pressure gas container according to Embodiment 1 of the invention.

FIG. 5 is a schematic process drawing illustrating a method of producing the high-pressure gas container according to Embodiment 1 of the invention.

FIG. 6 is a schematic process drawing illustrating the method of producing the high-pressure gas container according to Embodiment 1 of the invention.

FIG. 7 is a schematic sectional view in the axial direction of a high-pressure gas container according to Embodiment 2 of the invention.

FIG. 8 is a schematic sectional view of the high-pressure gas container taken on line C-C′ in FIG. 7.

FIG. 9 is a schematic sectional view of the high-pressure gas container taken on line D-D′ in FIG. 8.

FIG. 10 is a schematic process drawing illustrating a method of producing the high-pressure gas container according to Embodiment 2 of the invention.

FIG. 11 is a schematic process drawing illustrating the method of producing the high-pressure gas container according to Embodiment 2 of the invention.

FIG. 12 is a schematic sectional view of a high-pressure gas container in its axial direction according to Embodiment 3 of the invention.

FIG. 13 is a schematic process drawing illustrating a method of producing the high-pressure gas container according to Embodiment 3 of the invention.

FIGS. 14A, 14B and 14C are other examples of metal molds for extrusion molding used when the high-pressure gas container according to Embodiment 3 of the invention is produced.

### DETAILED DESCRIPTION OF THE PREFERRED EMBODIMENTS

A high-pressure gas container according to the invention is what has a resin hollow liner portion and a regulating portion disposed on the outer peripheral side of the liner portion. The high-pressure gas container is made excellent in strength by disposing the regulating portion on the outer peripheral side of the liner portion.

In the high-pressure gas container according to the invention, reinforcing ribs integral with the liner portion are provided on the inner peripheral side of the liner portion. This arrangement makes it feasible to greatly reduce not only the number of parts but that of manufacturing man-hours in comparison with a case where many reinforcing ribs are joined together for integration and where the liner portion is separately provided on the outer peripheral side of the combined ribs, whereby high-pressure gas containers can be manufactured easily and less costly.

Since the reinforcing ribs are provided on the inner peripheral side of the liner portion, the reinforcement and expansion of the liner portion are regulated by the reinforcing ribs. Therefore, the high-pressure gas container becomes superb in strength.

The liner portion has at least one part appearing on the inner surface of the high-pressure gas container as well as preventing the high-pressure gas filled in the high-pressure gas container from leaking out of the high-pressure gas container. The liner portion like this may be formed of resin of every kind having low gas permeability depending on the kind of high-pressure gas to be filled inside. When CNG gas is filled in, for example, the liner portion can be formed of material such as polyethylene allowing less CNG gas to permeate there through and when hydrogen gas is filled in, the liner portion can be formed of material such as EVOH allowing less hydrogen gas to permeate therethrough. However, use is not restricted to these materials mentioned above but can be made of various kinds of known materials.

In the high-pressure gas container according to the invention, the regulating portion is disposed on the outer peripheral side of the liner portion. As described above, it is only required for the regulating portion to be able to regulate the expansion of the liner portion and also to reinforce the liner portion. The regulating portion can be formed of known FRP made by impregnating reinforced fiber such as carbon fiber, glass fiber and aramid fiber with resin such as epoxy resin and then heat-hardening the resin.

A layer having low gas permeability or any one of the layers having weather-resistance may be disposed in a gap between the liner portion and the regulating portion or on the outer peripheral side of the regulating portion, depending on the kind of high-pressure gas to be filled in and the environment in which the high-pressure gas container is used.

If only the reinforcing ribs are projected into an inner hollow portion provided integrally with the liner portion on the inner peripheral side of the liner portion, they will meet the requirements; for example, they may be provided intermittently or otherwise extended continuously. In case that the reinforcing ribs are extended continuously, the external force applied to the reinforcing ribs is dispersed over the whole continuous portion of the reinforcing ribs, whereby the strength of the high-pressure gas container can greatly be improved. Moreover, only one reinforced rib or a plurality of them may be provided.

When the reinforcing ribs are continuously extended, the reinforcing ribs may be extended in the axial, circumferential or spiral direction. In addition, the reinforcing ribs may be extended in any direction other than the axial, circumferential or spiral direction.

When the reinforcing ribs are so provided as to be extended in the axial direction of the liner portion, the liner portion is especially axially reinforced by the reinforcing ribs, so that the axial strength of the high-pressure gas container is improved. When the reinforcing ribs are so provided as to be extended spirally in the axial direction of the liner portion along the inner surface of the liner portion, the liner portion is reinforced axially and circumferentially as well by the reinforcing ribs, so that the axial and circumferential strength of the high-pressure gas container is improved.

Since the reinforcing ribs are provided integrally with the liner portion, the high-pressure gas container having the reinforcing ribs can be produced easily and less costly. The reinforcing ribs are provided integrally with the liner portion without a gap or the like between the liner portion and the reinforcing ribs, whereby it is ensured that the liner portion is reinforced by the reinforcing ribs. As the liner portion is integral with the reinforcing ribs, it is also ensured that the external forced applied to the liner portion is transmitted to the reinforcing ribs, so that the strength of the liner portion is increased. The reinforcing ribs may be made of the same resin as that of the liner portion or any different material. Further, the reinforcing ribs may be formed integrally with the liner portion by any one of the known methods such as injection molding, extrusion molding and the like. The reinforcing ribs may be made by any known method of welding or bonding preformed separate bodies.

Even in case that the liner portion and the reinforcing ribs are disposed after the regulating portion is disposed, for example, the effect of reinforcing the liner portion and that of regulating the expansion of the liner portion are achievable by providing the reinforcing ribs as described above. Typically, however, the reinforcing ribs are integrated with the liner portion before the regulating portion is disposed.

Even when the regulating portion is formed by winding FRP in this case, the high-pressure gas container is strengthened but still less costly. In other words, even though the liner portion is pressed down by the tensile force of the reinforced fiber in the internal circumferential direction when the regulating portion is formed of FRP by winding the reinforced fiber on the outer peripheral side of the liner portion, the liner portion is restrained from contracting by the reinforcing ribs preprovided on the inner peripheral side of the liner portion. When the liner portion is thus restrained from contracting, the tensile force of the reinforced fiber wound on the outer peripheral side of the liner portion is sufficiently retained, whereupon the strength of the high-pressure gas container becomes sufficient without providing a thick regulating portion. As the contraction of the liner portion decreased, the external shape of the high-pressure gas container becomes sufficiently large and this makes it unnecessary to increase the external shape of the high-pressure gas container by providing such a thick regulating portion. Thus, the high-pressure gas container becomes superb in strength and producible less costly.

The high-pressure gas container according to the invention is not limited in shape as long as it is hollow inside and has an opening in at least one place, communicating with the inner hollow portion and opening outside the high-pressure gas container; for example, the opening may be cylindrical, square, spherical and so on. Further, the opening is formed by one or more than one sort of the liner portion, the regulating portion and the reinforcing ribs and serves as a gateway of high-pressure gas. The strength of the opening is increased by fitting a separately-formed metal cap, for example, to the inside or outside of the opening to integrate them whereby to facilitate the mounting of any other member to the opening.

In order to prevent the high-pressure gas filled in the high-pressure gas container from leaking out of the high-pressure gas container, the opening is typically covered with at least the liner portion and when a layer having low gas permeability is laid on the outer peripheral side of the liner portion, for example, the opening may be covered with the layer having low gas permeability. When a metal cap having low gas permeability is fitted to the opening, the high-pressure gas is prevented by the cap from leaking out. Consequently, the portion laid on the outer peripheral side or inner peripheral side of the cap may not necessarily be what has low gas permeability.

A plurality of split parts may be integrated to form the reinforcing ribs, the liner portion or the regulating portion. These split parts can be divided in the different directions of the high-pressure gas container and also joined together for integration through a known welding or bonding method. When the regulating portion is formed by winding FRP as described above, split parts formed with the reinforcing ribs and the liner portion may be coupled together for integration beforehand so as to form the regulating portion then. This arrangement is intended not only to prevent a portion of the high-pressure gas container, not vested with the tensile force of high-strength fiber, from being produced but to increase the whole strength of the high-pressure gas container.

### EXAMPLES

Working examples of the invention will now be described by reference to the accompanying drawings.

(Embodiment 1)

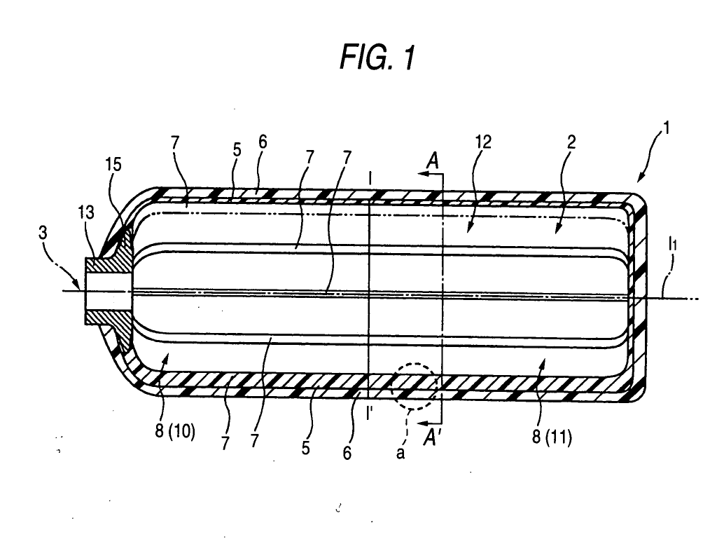

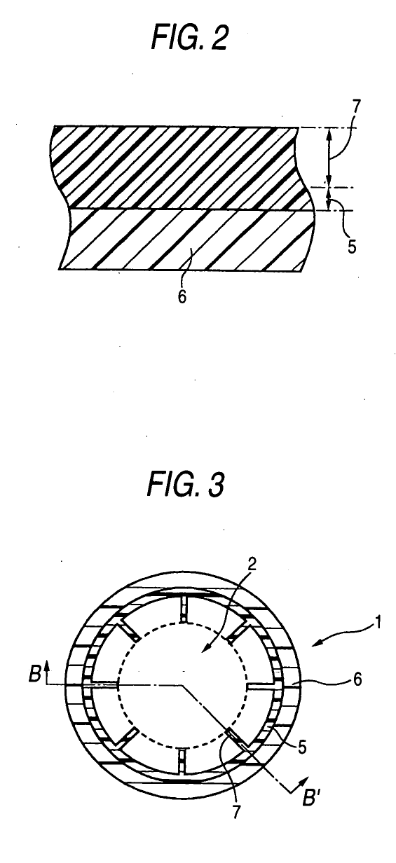

A high-pressure gas container according to Embodiment 1 of the invention is provided such that reinforcing ribs are extended in the axial direction of a liner portion. FIG. 1 is a schematic sectional view of a high-pressure gas container in its axial direction according to Embodiment 1 of the invention; FIG. 2, an enlarged view of a main part of a portion shown by a broken line a in FIG. 1; and FIG. 3, a schematic sectional view taken on line A-A′ in FIG. 1. Incidentally, FIG. 2 is a sectional view taken on line B-B′ in FIG. 3.

A high-pressure gas container 1 according to Embodiment 1 of the invention has an inner hollow portion 2 in a substantially cylindrical shape with one end opened axially and with the other end closed. High-pressure gas is filled in the inner hollow portion 2 through an opening 3 as an opened portion and emitted outside the high-pressure gas container 1 from the opening 3. The high-pressure gas container 1 has a liner portion 5 formed of PPS (Polyphenylene Sulfide), a regulating portion 6 formed of FRP and provided on the outer peripheral side of the liner portion 5, and reinforcing ribs 7 also formed of PPS integrally with the liner portion 5 on the inner peripheral side of the liner portion 5. Of these components, the reinforcing ribs 7 have a substantially flat platelike shape extending in the axial direction of the liner portion 5 and are provided in a row at substantially equal intervals in eight respective places. The liner portion 5 and the reinforcing ribs 7 are preformed integrally, divided into two split parts 8 by a dividing line I-I′ of the high-pressure gas container 1 and subjected to hot plate welding for integration. Of the split parts, the split part 8 on the side of the opening 3 forms a split part 10 on the opening side, whereas the split part 8 with one end closed axially forms a split part 11 on the closed side.

The inner surface 12 of the high-pressure gas container 1 is covered with the liner portion 5 and the reinforcing ribs 7. As the liner portion 5 and the reinforcing ribs 7 are made of PPS having low CNG-gas permeability, the high-pressure gas filled in the high-pressure gas container 1 is retained from leaking out of the high-pressure gas container 1 by the liner portion 5 and the reinforcing ribs 7. In this case, though the liner portion 5 and the reinforcing ribs 7 are formed of the same material having low gas permeability according to Embodiment 1 of the invention, only the reinforcing ribs 7 may be formed of material having high gas permeability, for example. The high-pressure gas is restrained from leaking out by the liner portion 5 provided on the outer peripheral side of the high-pressure gas container 1 than the reinforcing ribs 7 even in this case.

The regulating portion 6 consisting of carbon fiber as reinforced fiber and FRP containing epoxy resin as thermoplastic resin is wound on the liner portion 5 to cover the outer peripheral side of the liner portion 5 with the regulating portion 6.

The split part 10 on the opening side out of the split parts 8 is substantially cylindrical in shape with both its ends opened axially and one of its ends is reduced in diameter to form the opening 3. A metal cap 13 is joined to and integrated with the inner peripheral side of the opening 3. Of the cap 13, a flange portion 15 as an end portion of the split part 10 on the opening side is covered airtightly with the liner portion 5. It is therefore ensured that the inner hollow portion 2 of the high-pressure gas container 1 is covered with the cap 13 and the liner portion 5, whereby the high-pressure gas filled in the inner hollow portion 2 is prevented from leaking through a gap between the cap 13 and the liner portion 5.

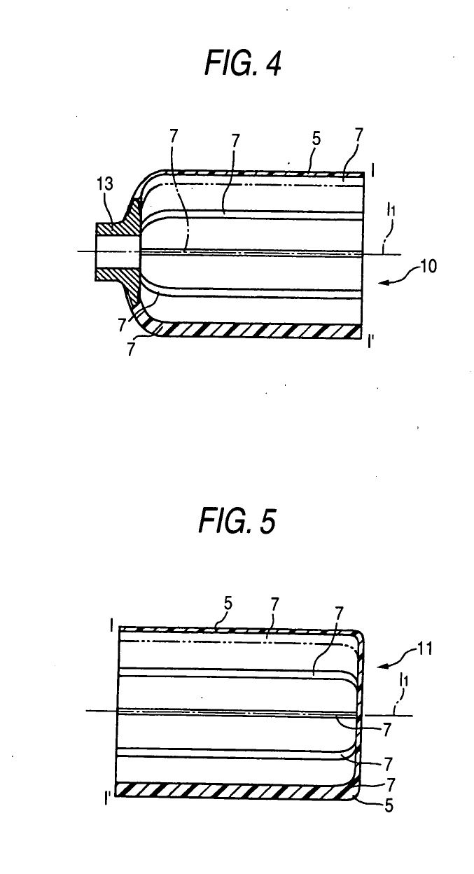

A method of producing the high-pressure gas container 1 according to Embodiment 1 of the invention will be described hereunder. FIGS. 4 to 6 are schematic process drawings illustrating a method of producing the high-pressure gas container 1 according to Embodiment 1 of the invention. (1) The split part 10 on the opening side, integral with the cap 13 of FIG. 4 is formed by placing the premolded cap 13 in a mold (not shown) and injecting molten PPS into the mold to form the liner portion 5 and the reinforcing ribs 7 by monolithic molding.

(2) The split part 11 on the closed side of FIG. 5 is formed by injecting molten PPS into another mold (not shown) to form the liner portion 5 and the reinforcing ribs 7 by monolithic molding.

(3) The split part 10 on the opening side, formed in (1) and the split part 11 on the closed side, formed in (2) are removed from the respective molds. While the center lines l₁ of the respective split parts 8 are aligned with each other, the split parts are made to face each other along the dividing line I-I′ and combined together by the hot plate welding whereby to form a first molded body having the cap 13, the liner portion 5 and the reinforcing ribs 7.

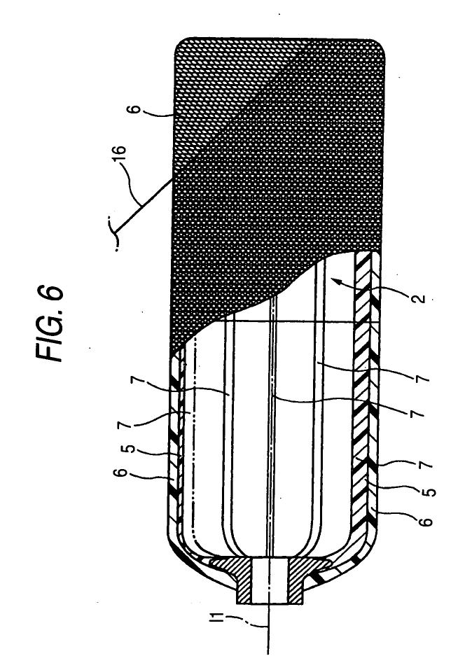

(4) Of the first molded body obtained in (3), carbon fiber 16 impregnated with epoxy resin is wound on the outer peripheral side of the liner portion 5 to cover the outer peripheral side of the liner portion 5 therewith as shown in FIG. 6. Then the regulating portion 6 is formed by hardening the epoxy resin with heat treatment. The high-pressure gas container 1 according to Embodiment 1 of the invention is produced through the consecutive steps (1)-(4) above.

As the reinforcing ribs 7 are provided on the inner peripheral side of the liner portion 5 of the high-pressure gas container 1 according to Embodiment 1 of the invention, the high-pressure gas container 1 is reinforced by the regulating portion 6 and the reinforcing ribs 7. Therefore, the high-pressure gas container 1 according to Embodiment 1 of the invention becomes superb in strength. As the reinforcing ribs 7 and the liner portion 5 are formed by monolithic molding, moreover, not only the number of parts but that of manufacturing man-hours is markedly reduced in comparison with a case where many reinforcing ribs 7 are joined together for integration and where the liner portion 5 is additionally provided on the outer peripheral side of the combined ribs. Thus, the high-pressure gas containers 1 can be manufactured easily and less costly.

The high-pressure gas container 1 becomes superb especially in axial strength since the reinforcing ribs 7 are extended in the axial direction of the liner portion 5. According to Embodiment 1 of the invention, the strength of the high-pressure gas container 1 in its circumferential direction is sufficient since a row of the reinforcing ribs 7 are provided along the internal periphery of the liner portion 5.

According to Embodiment 1 of the invention, the liner portion 5 and the reinforcing ribs 7 are integrally formed before the regulating portion 6 is wound thereon. Therefore, the liner portion 5 is reinforced by the reinforcing ribs 7 from its inner peripheral side when the liner portion 5 is pressed toward the inner hollow portion 2 by the tensile force of the carbon fiber contained in the regulating portion 6, whereby the liner portion 5 is prevented from contracting. Consequently, the tensile force of the carbon fiber contained in the regulating portion 6 becomes sufficient even in the side portion of the liner portion 5 and it is unnecessary to form the regulating portion 6 thick in order to make sufficient the strength of the high-pressure gas container 1. Since the liner portion 5 is restrained from contracting, the dimension of the external shape of the high-pressure gas container 1 does not become decreased by contraction and the regulating portion 6 needs not forming thick to make constant the dimension of the external shape thereof.

As the strength of the regulating portion 6 is demonstrated by the tensile force of the carbon fiber, the strength of the high-pressure gas container 1 is improved further even though the regulating portion 6 is not wound on the liner portion 5.

(Embodiment 2)

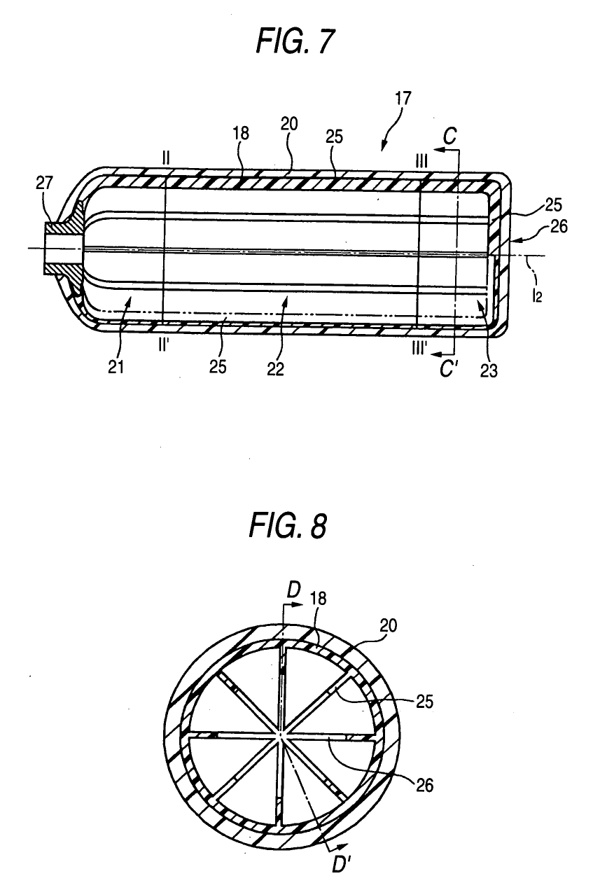

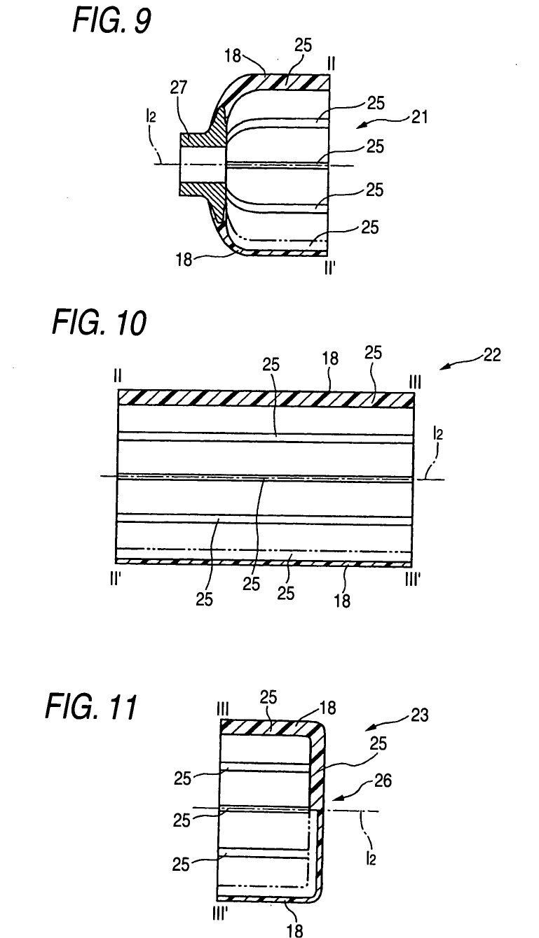

A high-pressure gas container according to Embodiment 2 of the invention has three split parts joined together. FIG. 7 is a schematic sectional view in the axial direction of a high-pressure gas container according to Embodiment 2 of the invention; FIG. 8, a schematic sectional view taken on line C-C′ in FIG. 7; and FIG. 9, a schematic sectional view taken on line D-D′ in FIG. 8.

A high-pressure gas container 17 according to Embodiment 2 of the invention has a liner portion 18, a regulating portion 20 and a cap 27 which are similar to those shown in Embodiment 1 of the invention. The split part is divided into three split parts by a dividing line II-II′ and a dividing line III-III′ of FIG. 7, including a split part 21 on the opening side, a central split part 22 and a split part 23 on the closed side which are joined together to form the liner portion 18 and reinforcing ribs 25. The high-pressure gas container 17 according to Embodiment 2 of the invention is similar to what is shown in Embodiment 1 thereof except that the reinforcing ribs 25 are provided such that they are set continuous to a bottom portion 26 as the closed end portion of the split part 23 on the closed side.

A method of producing the high-pressure gas container 17 according to Embodiment 2 of the invention will be described hereunder. FIGS. 9 to 11 are schematic process drawings illustrating the method of producing the high-pressure gas container 17 according to Embodiment 2 of the invention.

(1) The split part 21 on the opening side, integral with the cap 27 of FIG. 9 is formed by placing the premolded cap 27 in a mold (not shown) and injecting molten PPS into the mold and forming the liner portion 18 and the reinforcing ribs 25 by monolithic molding.

(2) The central split part 22 of FIG. 10 is formed integrally with the liner portion 18 and the reinforcing ribs 25 by extrusion molding by using molten PPS as material. As the central split part 22 is substantially constant in cross section, it can readily be formed by extrusion molding.

(3) The split part 23 on the closed side of FIG. 11 is formed by injecting molten PPS into another mold to form the liner portion 18 and the reinforcing ribs 25 by monolithic molding.

(4) The split part 21 on the opening side, formed in (1) and the split part 23 on the closed side, formed in (3) are removed from the respective molds. While the center lines l₂ are aligned with each other, the split part 21 on the opening side and the central split part 22 are made to face each other along the dividing line II-II′. While the center lines l₂ are aligned with each other, the central split part 22 and the split part 23 on the closed side are made to face each other along the dividing line III-III′. Then the three split parts are combined together by the hot plate welding whereby to form a first molded body having the cap 27, the liner portion 18 and the reinforcing ribs 25.

(5) Of the first molded body obtained in (4), carbon fiber impregnated with epoxy resin is wound on the outer peripheral side of the liner portion 18 to cover the outer peripheral side of the liner portion 18 therewith as in Embodiment 1 of the invention. Then the regulating portion 20 is formed by hardening the epoxy resin with heat treatment. The high-pressure gas container 17 according to Embodiment 2 of the invention is produced through the consecutive steps (1)-(5) above.

In the high-pressure gas container 17 according to Embodiment 2 of the invention, the reinforcing ribs 25 extending in the axial direction of the liner portion 18 and the liner portion 18 are integrally formed before the regulating portion 20 is wound thereon, whereby excellent strength is demonstrated as in the high-pressure gas container 17 according to Embodiment 1 of the invention.

As the reinforcing ribs 25 are set continuous to the bottom portion 26, the strength of the high-pressure gas container 17 in its circumferential direction is improved. According to Embodiment 2 of the invention, since the liner portion 18 and the reinforcing ribs 25 of the high-pressure gas container 17 are integrated with the three split parts joined together, the length l of the split part 23 on the closed side can relatively be shortened. Accordingly, even though the internal shape of the split part 23 on the closed side is complicated, the split part 23 on the closed side becomes easily removed from the mold at Step (4). Further, the number and size of molds for integrally forming the liner portion 18 and the reinforcing ribs 25 are reducible as the central split part 22 is easily formable by extrusion molding. Thus, the high-pressure gas container 17 according to Embodiment 2 of the invention demonstrates excellent strength and can be produced easily and less costly.

(Embodiment 3)

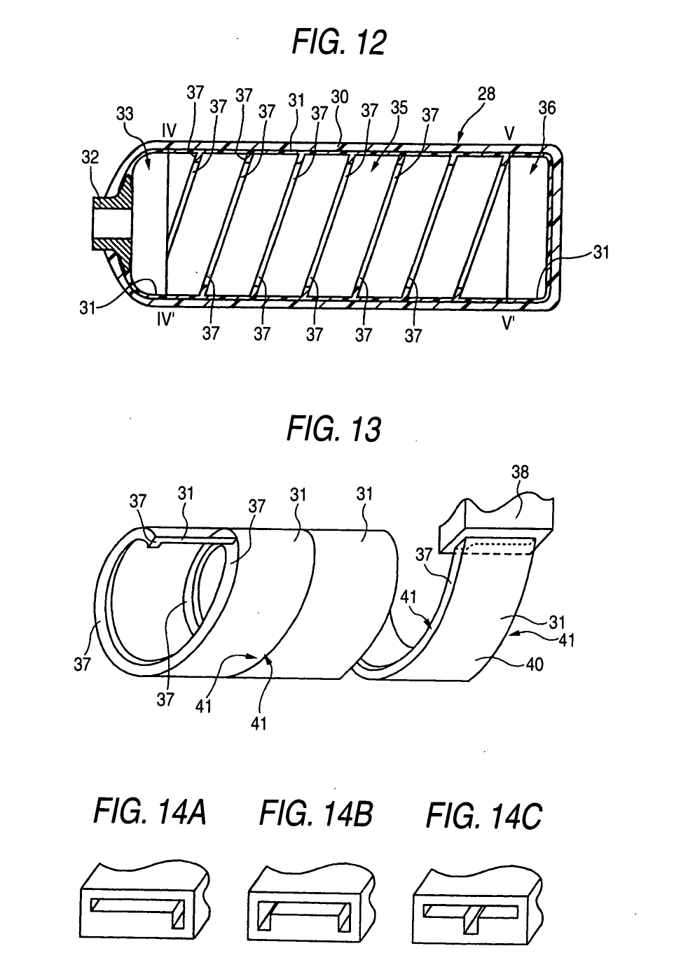

A high-pressure gas container according to Embodiment 3 of the invention is provided such that reinforcing ribs are spirally extended in the axial direction of a liner portion. FIG. 12 is a schematic sectional view of the high-pressure gas container in its axial direction according to Embodiment 3 of the invention.

A high-pressure gas container 28 according to Embodiment 3 of the invention has a regulating portion 30, a liner portion 31, and a cap 32 which are similar to those shown in Embodiment 1 of the invention. The split part is divided into three split parts by a dividing line VI-VI′ and a dividing line V-V′ of FIG. 12, including a split part 33 on the opening side, a central split part 35 and a split part 36 on the closed side which are joined together to form the liner portion 31 and reinforcing ribs 37. The reinforcing ribs 37 are provided in only the central split part 35 according to Embodiment 3 of the invention.

In the high-pressure gas container 28 according to Embodiment 3 of the invention, the reinforcing ribs 37 are provided such that they are spirally extended in the axial direction of the liner portion 31 while wound up along the inner surface of the liner portion 31.

A method of producing the high-pressure gas container 28 according to Embodiment 3 of the invention will be described hereunder. FIG. 13 is a schematic process drawing illustrating the method of producing the high-pressure gas container 28 according to Embodiment 3 of the invention.

(1) The split part 33 on the opening side, integral with the cap 32 is formed by placing the premolded cap 32 in a mold (not shown) and injecting molten PPS into the mold to form the liner portion 31 by monolithic molding.

(2) The split part 36 on the closed side is formed by injecting molten PPS into another mold to form the liner portion 31.

(3) With molten PPS used as material, a belt-like body 40 integrally incorporating the liner portion 31 and the reinforcing ribs 37 is formed by extrusion molding with a substantially L-shaped metal mold 38 in cross section as shown in FIG. 13. At this time, the belt-like body 40 is extruded in a curved condition by a guide member (not shown) so that the reinforcing ribs 37 are situated on the inner peripheral side with the liner portion 31 situated on the outer peripheral side of the belt-like body 40. The sides 41 of the curved belt-like body 40 thus extruded are made to adhere to each other by winding the belt-like body 40 side by side to assume a substantially cylindrical shape whereby to make one side 41 contact against another before the molten resin is completely cooled and solidified. Then the cylindrical central split part 35 is formed by cutting off both end portions in the axial direction. In the central split part 35, the liner portion 31 and the reinforcing ribs 37 are formed so as to have constant thickness corresponding to the shape of the metal mold 38. Since the reinforcing ribs 37 are formed by extrusion molding integrally with the liner portion 31, the reinforcing ribs 37 of the central split part 35 are provided such that they are spirally extended in the axial direction of the liner portion 31 while wound up along the inner surface of the liner portion 31. Although the L-shaped metal mold 38 has been employed for extrusion molding according to Embodiment 3 of the invention, the metal mold is not limited to the L-shape but may have any other shape on condition that the liner portion 31 and the reinforcing ribs 37 can simultaneously be subjected to extrusion molding. For example, use can be made of typically what is substantially L-shaped in cross section of FIG. 14A, substantially II-shaped in cross section of FIG. 14B, substantially T-shaped in cross section of FIG. 14C or the like.

(4) The split part 33 on the opening side, formed in (1) and the split part 36 on the closed side, formed in (2) are removed from the respective molds, and the split part 33 on the opening side and the central split part 35 are made to face each other along the dividing line IV-IV′. Simultaneously, the central split part 35 and the split part 36 on the closed side are made to face each other along the dividing line V-V′ and then the three split parts are combined together by the hot plate welding whereby to form a first molded body having the cap 32, the liner portion 31 and the reinforcing ribs 37.

(5) Of the first molded body obtained in (4), carbon fiber impregnated with epoxy resin is wound on the outer peripheral side of the liner portion 31 to cover the outer peripheral side of the liner portion 31 therewith as in Embodiment 1 of the invention. Then the regulating portion 30 is formed by hardening the epoxy resin with heat treatment. The high-pressure gas container 28 according to Embodiment 3 of the invention is produced through the consecutive steps (1)-(5) above.

As the reinforcing ribs 37 and the liner portion 31 of the high-pressure gas container 28 according to Embodiment 3 of the invention are integrally formed with the regulating portion 30 formed by winding after the reinforcing ribs 37 and the liner portion 31 are integrally formed, excellent strength is demonstrated as in the case of the high-pressure gas container 1 according to Embodiment 1 of the invention. As the reinforcing ribs 37 are spirally provided, strength in both axial and circumferential directions is demonstrated as well. Further, the number and size of molds for integrally forming the liner portion 31 and the reinforcing ribs 37 are reducible as the central split part 22 is easily formable by extrusion molding. Thus, the high-pressure gas container 28 according to Embodiment 3 of the invention demonstrates excellent strength and can be produced easily and less costly.

As set forth above, the high-pressure gas containers according to the invention are made superb in strength and readily producible less costly by providing the reinforcing ribs integrally with the liner portion on the inner peripheral side of the liner portion.

1. A high-pressure gas container comprising:
a liner portion made of a resin having a hollow inside;
a regulating portion disposed on an outer surface of the liner portion;
at least one reinforcing rib provided integrally with the liner portion on an inner surface of the liner portion for reinforcing the liner portion so as to be projected toward the hollow inside of the liner portion.

2. A high-pressure gas container according to claim 1, wherein the liner portion is formed substantially in a cylindrical shape and the reinforcing rib is extended in an axial direction of the liner portion.

3. A high-pressure gas container according to claim 1, wherein the liner portion is formed substantially in a cylindrical shape and the reinforcing rib is extended spirally in an axial direction of the liner portion so as to be wound up along the inner surface of the liner portion.

4. A high-pressure gas container according to claim 1, wherein the reinforcing ribs and the liner portion are integrated before the regulating portion is arranged.

5. A high-pressure gas container according to claim 2, wherein a plurality of the reinforcing ribs are formed on the inner surface of the liner portion, and
the plurality of the reinforcing ribs are arranged at substantially equal intervals in a circumferential direction of the liner portion.

6. A high-pressure gas container according to claim 1, wherein the liner portion is made of PPS.

7. A high-pressure gas container according to claim 1, wherein the liner portion and the reinforcing rib are formed of the same material.

8. A high-pressure gas container according to claim 1, wherein the regulating portion is made of a composite containing a fiber material and a resin.

9. A method for forming a high-pressure gas container, comprising:
molding a molten material into a molded body by a mold;
forming integrally a liner portion and a reinforcing rib; wherein the reinforcing rib projects from an inner surface of the liner portion;
winding a regulating portion around the liner.

10. A method for forming a high-pressure gas container according to claim 9, wherein the reinforcing ribs and the liner portion are integrated before the regulating portion is arranged.

11. A method for forming a high-pressure gas container according to claim 9, wherein a plurality of split parts of the liner portion are formed by injection molding, and the split parts are combined into a single body by a hot plate welding to thereby form the liner portion.

12. A method for forming a high-pressure gas container according to claim 9, wherein a belt-like body is molded from the molten material by extrusion molding, and the belt-like body is wound to thereby form the liner portion.

13. A high-pressure gas container according to claim 2, wherein the liner portion includes a first split part located on an opening side of the liner portion and a second split part located on a closed side opposite to the opening side.

14. A high-pressure gas container according to claim 13, wherein the reinforcing rib is formed on each of the first and second split parts and the reinforcing rib is integrated at a connection portion between the first and second split parts.

15. A high-pressure gas container according to claim 13, wherein the reinforcing rib is formed on a bottom of the second split part.

16. A high-pressure gas container according to claim 2, wherein the liner portion includes a first split part located on an opening side of the liner portion, a second split part located on a closed side opposite to the opening side, and a third split part located between the first and second split parts.

17. A high-pressure gas container according to claim 16, the reinforcing rib is formed on each of the first, second and third split parts and the reinforcing rib is integrated at connection portions between the first and third split parts as well as between the second and third split parts.

18. A high-pressure gas container according to claim 16, wherein the reinforcing rib is formed on a bottom of the second split part.

19. A high-pressure gas container according to claim 16, wherein the third split part is formed so as to integrally provided with the reinforcing rib by extrusion.
